(19) United States
(12) Patent Application Publication
(10) Pub. No.: US 2016/0171773 A1
(43) Pub. Date: Jun. 16, 2016

(54) DISPLAY CONTROL METHOD, INFORMATION PROCESSING APPARATUS, AND STORAGE MEDIUM

(71) Applicant: FUJITSU LIMITED, Kawasaki-shi (JP)

(72) Inventor: HIDEKI HARA, Yokohama (JP)

(73) Assignee: FUJITSU LIMITED, Kawasaki-shi (JP)

(21) Appl. No.: 14/949,440

(22) Filed: Nov. 23, 2015

(30) Foreign Application Priority Data
Dec. 10, 2014 (JP) 2014-249875

(51) Int. Cl. G06T 19/00; G06K 9/46; H04N 5/232

(52) U.S. Cl. CPC G06T 19/006; H04N 5/23229; G06K 9/4671

(57) ABSTRACT

A method performed by an information processing apparatus includes obtaining a captured image captured by an imaging device, extracting one or more reference objects included in the captured image according to a predetermined rule, and displaying one or more associated images associated with the extracted one or more reference objects on a display.

### CROSS-REFERENCE TO RELATED APPLICATION

This application is based upon and claims the benefit of priority of Japanese Patent Application No. 2014-249875 filed on Dec. 10, 2014, the entire contents of which are incorporated herein by reference.

### FIELD

An aspect of this disclosure relates to a display control method, an information processing apparatus, and a storage medium.

### BACKGROUND

Augmented reality (AR) is a technology to superimpose content information on a part of a captured image captured by an imaging unit of a terminal. A display position in a virtual space corresponding to a real space is set for each content (which is hereafter referred to as an “AR content”) provided using the AR technology.

For example, a terminal superimposes an AR content on a captured image in response to detection of a reference object (e.g., a marker) in the captured image. The terminal obtains a positional and orientational relationship between the reference object and its imaging unit, and superimposes the AR content on the captured image at a position, a size, and an orientation determined based on the positional and orientational relationship. The position where the AR content is displayed is determined relative to the position, the size, and the orientation of the reference object (see, for example, Japanese Laid-Open Patent Publication No. 2002-092647).

### SUMMARY

According to an aspect of this disclosure, there is provided a method performed by an information processing apparatus. The method includes obtaining a captured image captured by an imaging device, extracting one or more reference objects included in the captured image according to a predetermined rule, and displaying one or more associated images associated with the extracted one or more reference objects on a display.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of an information processing system;

FIG. 2 is a block diagram illustrating an exemplary functional configuration of a server;

FIG. 3 is a block diagram illustrating an exemplary functional configuration of a terminal;

FIG. 4 is a block diagram illustrating an exemplary hardware configuration of a server;

FIG. 5 is a block diagram illustrating an exemplary hardware configuration of a terminal;

FIG. 6 is a flowchart illustrating an exemplary display control process;

FIGS. 7A and 7B are drawings illustrating exemplary screens according to a first embodiment;

FIG. 8 is a flowchart illustrating an exemplary object extraction process according to a second embodiment;

FIG. 9A is an example of an AR marker recognition information management table;

FIG. 9B is an example of a recognition count table;

FIGS. 10A through 10C are drawings used to describe the second embodiment;

FIG. 11 is a flowchart illustrating an exemplary object extraction process according to a third embodiment;

FIG. 12A is a drawing illustrating exemplary movement trace data;

FIG. 12B is a drawing illustrating exemplary movement of a user;

FIG. 13 is a flowchart illustrating an exemplary object extraction process according to a fourth embodiment; and

FIGS. 14A and 14B are drawings illustrating exemplary screens according to the fourth embodiment.

### DESCRIPTION OF EMBODIMENTS

With the related-art technologies described above, when multiple reference objects exist in an image, all AR contents corresponding to the reference objects are superimposed on the image. As a result, the AR contents may overlap each other and become unrecognizable.

It is possible to avoid capturing multiple reference objects by capturing an image from a close distance and thereby decreasing the angle of view. In this case, however, it may become difficult to display AR contents on the captured image due to the decreased angle of view.

An aspect of this disclosure provides a display control method, an information processing apparatus, and a storage medium that can prevent multiple images associated with reference objects from overlapping each other.

Embodiments of the present invention are described below with reference to the accompanying drawings.

### <Configuration of Information Processing System>

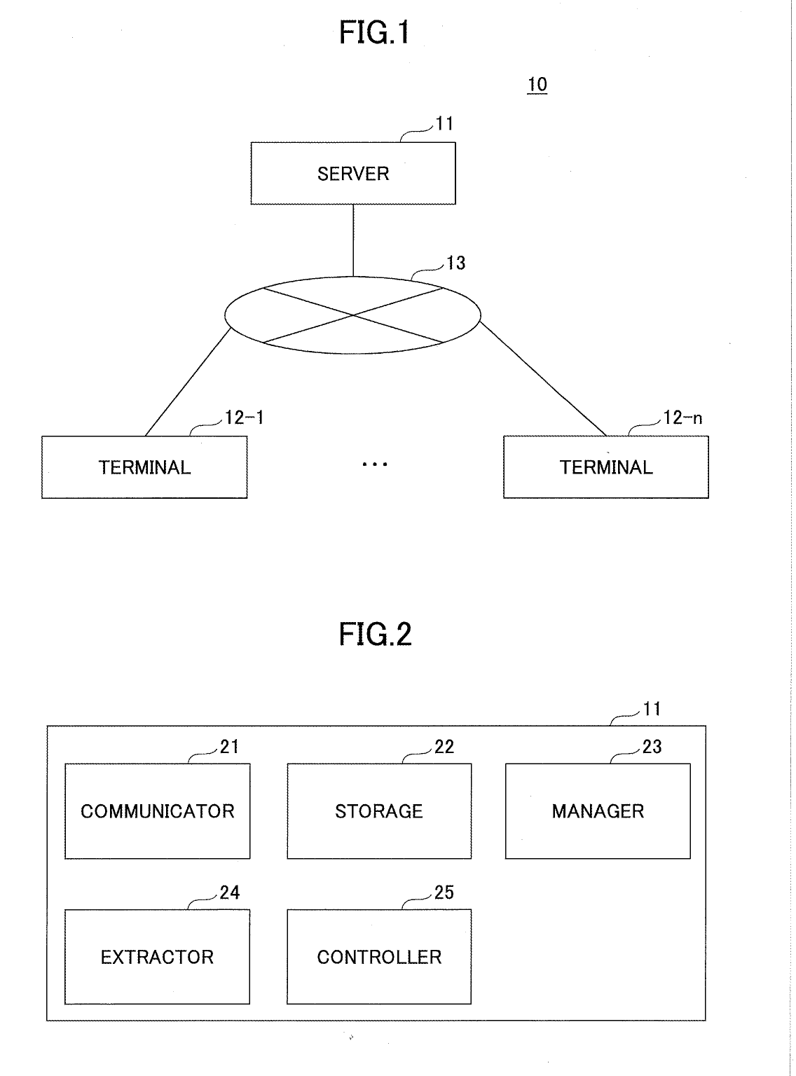

FIG. 1 is a drawing illustrating an exemplary configuration of an information processing system 10. As illustrated by FIG. 1, the information processing system 10 may include a server 11 and one or more terminals 12-1 through 12-n (which may be collectively referred to as a “terminal 12” or “terminals 12”) that are examples of information processing apparatuses. The server 11 and the terminals 12 are connected to each other via, for example, a communication network 13 so as to be able to send and receive data.

The server 11 manages, for example, AR markers that are examples of reference objects, one or more AR contents registered in association with each of the AR markers, and various criteria for display control of the terminals 12. An AR marker specifies, for example, content information such as an AR content and a position where the content information is to be displayed. An AR marker is, for example, but not limited to, an image that is formed in a predetermined area and represents a graphical or character pattern such as a two-dimensional code.

A reference object is not limited to an AR marker. Any object whose feature values can be extracted by, for example, edge extraction based on differences from surrounding pixels may be used as a reference object. Examples of such objects include a clock, a machine, a window, a painting, an ornament, a personal computer (PC), a pillar, and piping. For example, feature values of various objects may be stored in advance (e.g., as an object recognition dictionary) and compared with feature values of an object obtained from image data to recognize the object, identify an AR content associated with the object, and determine a relative position (coordinates) of the AR content relative to the object.

An AR content is, for example, image data such as three-dimensional object model data disposed on a three-dimensional virtual space corresponding to a real space. Also, an AR content is superimposed information superimposed on an image captured by the terminal 12. For example, an AR content is displayed at a position specified by relative coordinates in a relative coordinate system (marker coordinate system) relative to an AR marker included in a captured image. According to the present embodiment, AR contents are associated with AR markers. Examples of AR contents include text, icons, animations, marks, patterns, images, and videos. AR contents are not limited to information to be displayed, but may also be other types of information such as audio.

When receiving information (e.g., a marker ID) regarding an AR marker from the terminal 12, the server 11 sends, for example, an AR content corresponding the marker ID, setting information of an recognition area corresponding to a partial area of image data, and extraction criteria of AR markers, to the terminal 12. The recognition area and the extraction criteria are examples of predetermined rules.

However, the present invention is not limited to this embodiment. For example, the server 11 may be configured to receive a marker ID, positional information, and a captured image from the terminal 12, and to extract and determine an AR marker based on predefined object extraction criteria. Also, the server may be configured to retrieve an AR content associated with a marker ID extracted based on the determination result, and send the retrieved AR content to the terminal 12.

The server 11 may be implemented by a personal computer (PC). However, the server 11 is not limited to a PC. For example, the server 11 may be a cloud server implemented by one or more information processing apparatuses in a cloud computing system.

The terminal 12, for example, registers AR contents in association with AR markers, determines whether an image of an AR marker is included in an image obtained by, for example, capturing, and displays an AR content (e.g., other image data) based on the determination result.

For example, the terminal 12 performs a determination process (which is hereafter referred to as “marker recognition”) for determining whether image data of an AR marker is included in a recognition area corresponding to a partial area of an image captured by an imaging device such as a built-in camera or obtained via the communication network 13 from an external apparatus. Also, based on the determination result, the terminal 12 performs an output control process for determining whether to superimpose an AR content associated with the AR marker on image data (e.g., controls whether to output the AR content or selects information to be output).

Also, when an AR marker is included in an image, the terminal 12 may be configured to control whether to display an AR content based on the movement direction of the AR marker. Also, the terminal 12 may be configured to calculate a distance of an AR marker from a position on an image specified by a user, and to control whether to display the corresponding AR content based on the calculated distance. For example, when multiple AR markers are included in image data, the terminal 12 may be configured to display only AR contents corresponding to a predetermined number of AR markers.

Further, the terminal 12 may be configured to send information on an AR marker recognized by the marker recognition and positional information to the server 11, and to perform a display control process based on the result of determination performed at the server 11.

The terminal 12 may be, but is not limited to, a tablet terminal, a smart device such as a smartphone, a personal digital assistant (PDA), or a notebook PC. The terminal 12 may also be a game machine or a communication terminal such as a cell phone. Further, the terminal 12 may be a wearable device worn by a user. Examples of wearable devices include a head-mounted display and an eyeglass-type display.

The communication network 13 is, for example, but not limited to, the Internet or a local area network (LAN). Also, the communication network 13 may be a wired network, a wireless network, or a combination of them.

In the information processing system 10 of FIG. 1, one server 11 is provided for multiple terminals 12. However, the present invention is not limited to this configuration. For example, the information processing system 10 may include multiple severs 11.

### <Functional Configuration of Server>

An exemplary functional configuration of the server 11 is described below. FIG. 2 is a block diagram illustrating an exemplary functional configuration of the server 11. The server 11 may include a communicator 21, a storage 22, a manager 23, an extractor 24, and a controller 25.

The communicator 21 sends and receives data via the communication network 13 to and from the terminal 12 and other computers. For example, the communicator 21 receives, from the terminal 12, a registration request to register AR markers, and AR contents and determination criteria such as image characteristic information to be registered in association with the AR markers. Also, the communicator 21 receives identification information (e.g., a marker ID) of a registered AR marker, and sends a determination criterion and an AR content corresponding to the identification information to the terminal 12.

The storage 22 stores various types of information (e.g., marker IDs, AR contents, recognition areas, and extraction criteria) used for a display control process of the present embodiment. For example, the storage 22 may store setting information generated at the terminal 12 when generating AR contents, image characteristic information set for respective AR markers, one or more AR contents, and time information.

The manager 23 manages various types of registration information such as AR contents obtained from the terminal 12. For example, the manager 23 registers identification information (marker IDs) of AR markers in association with one or more sets of AR content information. The registered information items are stored in the storage 22.

The extractor 24 refers to the storage 22 based on identification information (marker ID) obtained from the terminal 12 to extract AR content information, a recognition area, and extraction criteria associated with the identification information. The information items extracted by the extractor 24 are sent by the communicator 21 to the terminal 12 that has sent the identification information.

The controller 25 controls other components of the server 11. For example, the controller 25 controls transmission and reception of information by the communicator 21, storage of data by the storage 22, registration of AR contents, recognition areas, and extraction criteria by the manager 23, and extraction of AR contents, recognition areas, and extraction criteria by the extractor 24. Control processes performed by the controller 25 are not limited to those described above.

### <Functional Configuration of Terminal>

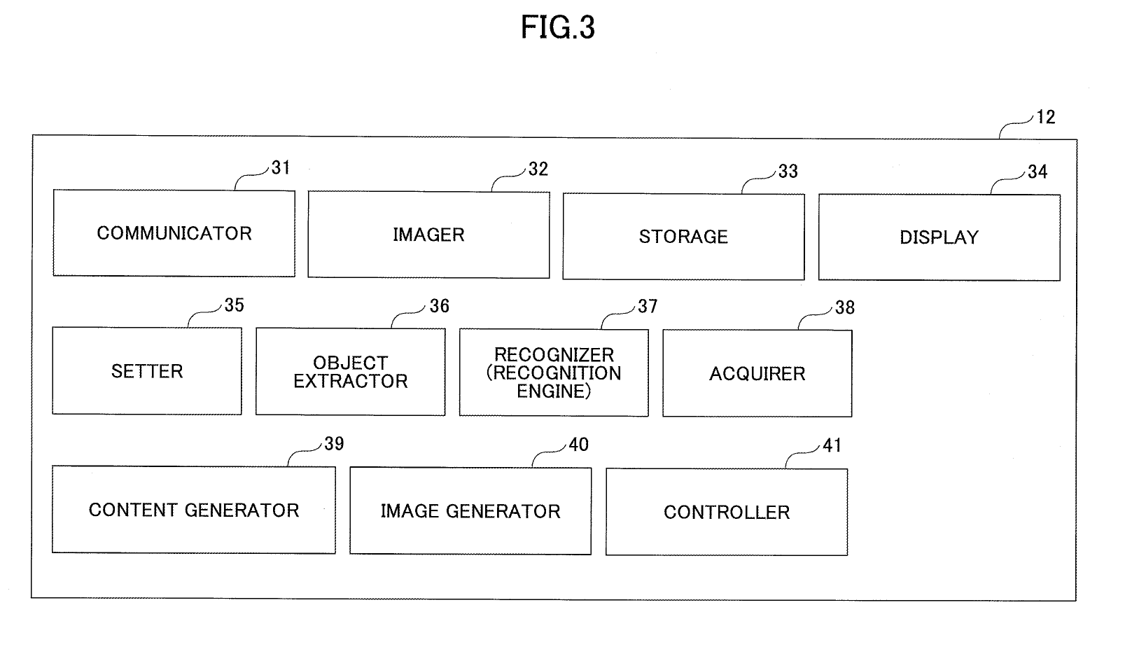

An exemplary functional configuration of the terminal 12 is described below. FIG. 3 is a block diagram illustrating an exemplary functional configuration of the terminal 12. The terminal 12 may include a communicator 31, an imager (imaging device) 32, a storage 33, a display 34, a setter 35, an object extractor 36, a recognizer (recognition engine) 37, an acquirer 38, a content generator 39, an image generator 40, and a controller 41.

The communicator 31 sends and receives data via the communication network 13 to and from the server 11 and other computers. For example, the communicator 31 sends, to the server 11, AR content information and setting information that are associated with AR markers. The setting information, for example, includes determination criteria represented by image characteristic information. Also, the communicator 31 sends a marker ID recognized by marker recognition to the server 11, and receives a determination criterion and an AR content corresponding to the sent marker ID from the server 11.

The imager 32, for example, captures images at a predetermined frame interval. The imager 32 outputs the captured images to the controller 41 or stores the captured images in the storage 33.

The storage 33 stores various types of information used for a display control process of the present embodiment. For example, the storage 33 stores AR markers registered in association with AR contents, and AR contents to be displayed based on recognition results of reference objects such as AR markers. The storage 33 may also store conditions (e.g., recognition areas) for recognizing reference objects, and object extraction criteria for extracting an AR marker corresponding to an AR content to be displayed from AR markers in an image. Further, the storage 33 may temporarily store, for example, an AR marker recognition status and an object extraction status that change as time passes. The storage 33 may store not only information set by the terminal 12, but also information obtained from the server 11. Information set by the terminal 12 may be deleted from the storage 33 after the information is sent to the server 11.

Based on recognition and determination results of the recognizer 37, the display 34 displays, for example, a screen for registering an AR content for a captured image generated by the image generator 40, a superimposed image where the registered AR content is superimposed on the captured image, and other setting screens. When the display 34 includes a touch panel, the display 34 can also obtain coordinates of a touched position on the touch panel.

The setter 35 sets AR contents to be displayed based on determination criteria after AR markers are recognized, and positions at which the AR contents are displayed. The setter 35 sends the set information to the server 11 and thereby requests registration of the set information.

Also, the setter 35 can set, as determination criteria, information items that include, but are not limited to, image characteristic information, time information, and information on reference objects other than AR markers.

The object extractor 36 extracts a partial area, on which a recognition and determination process is performed, from image data captured by the imager 32 or obtained by the acquirer 38. Here, a partial area (recognition area) indicates an area that is included in a captured or obtained image and is smaller than the entire area of the image. One or more non-overlapping partial areas may be extracted. When multiple partial areas are extracted, the sizes of the partial areas are not necessarily the same.

Also, when multiple objects are recognized in the entire image by the recognizer 37, the object extractor 36 may be configured to extract AR markers based on a predetermined extraction criterion. For example, the object extractor 36 may be configured to count the number of times each AR marker is recognized (i.e., the number of occurrences of each AR marker) in image data (multiple images) obtained within a predetermined time period, and extract one or more AR markers, in which the user seems to be more interested, based on the counting results.

The object extractor 36 may also be configured to extract one or more AR markers in which the user seems to be interested, based on a trace of movement indicated by images captured by the terminal 12 over time. Further, the object extractor 36 may be configured to assume that the user is interested in an AR marker closest to the central portion of a screen of the terminal 12 or a position (specified position) on the screen tapped by the user, and extract the AR marker.

Although any number of AR markers may be extracted, it is preferable to not extract all of recognized AR markers to prevent AR contents corresponding to the extracted AR markers from overlapping each other and becoming unrecognizable.

The recognizer 37 is a recognition engine that recognizes reference objects such as AR markers included in a partial area extracted by the object extractor 36. For example, the recognizer 37 performs image recognition on a partial area of image data captured by the imager 32 or obtained by the acquirer 38, and determines whether images representing AR markers are included in the partial area. When one or more images representing AR markers are included in the partial area, the recognizer 37 obtains information (e.g., images) on the AR markers. Also, the recognizer obtains positions (coordinates) of the AR markers relative to the imager 32, and identification information (marker IDs) of the AR markers. In the present embodiment, there is a case where the same identification information is obtained from different reference objects (AR markers).

The recognizer 37 may also be configured to perform an AR marker recognition process on the entire image. In this case, the recognizer 37 outputs AR markers recognized in the entire image to the object extractor 36, and the object extractor 36 extracts, from the recognized AR markers, one or more AR markers whose AR contents are to be displayed.

A reference object in the present embodiment is not limited to an AR marker. For example, any pre-registered object (e.g., a clock, a painting, an ornament, a PC, a pillar, or piping) may be used as a reference object. In this case, for example, the recognizer 37 may be configured to obtain the highest and lowest luminance values in a predetermined area of a captured image, and to recognize an object based on feature values in the area that are represented by differences (luminance differences) from the highest and lowest luminance values. Also, the recognizer 37 may be configured to store, in advance, templates defining the shapes of AR markers and objects in the storage 33, and to recognize AR markers and objects by template matching.

The recognizer 37 determines whether a registered object is included in an input image and when a registered object is included in the input image, obtains identification information corresponding to the registered object.

The acquirer 38 obtains an AR content corresponding to the identification information such as a marker ID obtained by the recognizer 37. The acquirer 38 may also obtain positional and rotational (angle) information of the AR marker corresponding to the marker ID obtained by the recognizer 37. The acquirer 38 may perform an acquisition process immediately after a recognition process is performed by the recognizer 37, or at any other timing. Also, the acquirer 38 may be configured to obtain image data captured by an external apparatus such as another terminal 12. Further, the acquirer 38 may be configured to obtain an AR content based on an object (image) recognized by another terminal 12.

The content generator 39 generates an AR content that is displayed at a position relative to coordinates of an AR marker recognized by the recognizer 37. The AR content is obtained, for example, by the acquirer 28 and is displayed at a position relative to the coordinates of the AR marker. As a non-limiting example, relative-position information indicating the relative position of the AR content may be obtained by converting a point specified on a screen by a user via the content generator 39 into coordinates in a coordinate system (marker coordinate system) having its origin at the position of the AR marker.

The image generator 40 generates a superimposed image (composite image) by superimposing, on obtained image data (e.g., a captured image), an AR content corresponding to a result of a determination process performed based on, for example, an AR marker or image characteristic information. Also, the image generator 40 may be configured to superimpose different AR contents on image data depending on the time at which the image data is obtained. As a non-limiting example, the image generator 40 displays an AR content on a screen at a position relative to an AR marker.

The controller 41 controls other components of the terminal 12 and processes performed by those components. For example, the controller 41 causes the imager 32 to capture an image, causes the display 34 to display various types of information on a screen of the terminal 12, and causes the setter 35 to make various settings related to display control according to the present embodiment.

The controller 41 also causes the recognizer 37 to recognize AR markers and object information in a captured image, causes the acquirer 38 to obtain characteristic information included in an image, causes the content generator 39 to generate AR contents, and causes the image generator 40 to generate a superimposed image.

According to the present embodiment, a reference object such as an AR marker is attached to an object (physical object) in a real space, and an AR content is associated with identification information of the AR marker so that the AR content representing, for example, instructions, steps, and notes for using the object can be superimposed on a captured image including the object.

### <Hardware Configuration of Server>

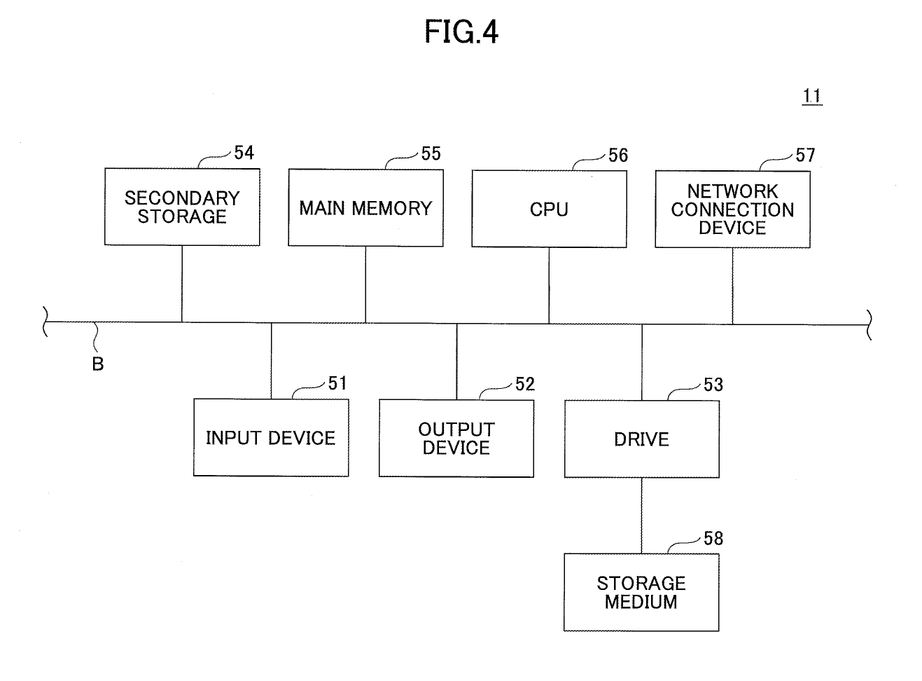

An exemplary hardware configuration of the server 11 is described below. FIG. 4 is a block diagram illustrating an exemplary hardware configuration of the server 11. As illustrated by FIG. 4, the server 11 may include an input device 51, an output device 52, a drive 53, a secondary storage 54, a main memory 55, a central processing unit (CPU) 56, and a network connection device 57 that are connected to each other via a system bus B.

The input device 51 may include a keyboard and a mouse operated by a user such as a server administrator and an audio input device such as a microphone, and may receive, for example, user inputs such as an instruction to execute a program, operational information, and information for activating software.

The output device 52 may include a display that displays various windows and data necessary to operate a computer (the server 11) that performs various processes according to the present embodiment. According to a control program of the CPU 56, the output device 52 can display progress and results of executed programs.

In the present embodiment, execution programs to be installed into the computer may be provided via a storage medium 58. The storage medium 58 can be set on the drive 53. According to a control signal from the CPU 56, execution programs stored in the storage medium 58 are installed via the drive 53 into the secondary storage 54.

The secondary storage 54 may be implemented by a storage device such as a hard disk drive (HDD) or a solid state drive (SSD). According to a control signal from the CPU 56, the secondary storage 54 stores and outputs an execution program (information processing program) of the present embodiment and control programs provided for the computer. Also, the secondary storage 54 reads necessary information stored therein and writes information thereto according to control signals from the CPU 56.

The main memory 55 stores, for example, execution programs read by the CPU 56 from the secondary storage 54. The main memory 55 may be implemented by, for example, a read-only memory (ROM) and/or a random access memory (RAM).

The CPU 56 controls the entire computer according to control programs such as an operating system (OS) and execution programs stored in the main memory 55 to perform, for example, various calculations and data input/output between the CPU 56 and other hardware components. The CPU 56 may obtain information necessary for the execution of programs from the secondary storage 54 and store execution results in the secondary storage 54.

For example, the CPU 56 loads a program installed in the secondary storage 54 onto the main memory 55 and executes the loaded program according to an execution instruction input via the input device 51 to perform a process corresponding to the program. More specifically, the CPU 56 executes an information processing program to cause the manager 23 to manage marker IDs and AR contents and register criteria for determining AR markers to be recognized, cause the extractor 24 to retrieve various types of information, and cause the controller 25 to perform a display control process. Processes performed by the CPU 56 are not limited to those described above. Results of processes performed by the CPU 56 may be stored in the secondary storage 54 as necessary.

The network connection device 57 communicates via the communication network 13 with the terminals 12 and other external apparatuses. According to a control signal from the CPU 56, the network connection device 57 connects the server 11 to, for example, the communication network 13 to obtain execution programs, software, and setting information from external apparatuses. Also, the network connection device 57 may be configured to provide results obtained by executing programs to the terminals 12, and to provide an execution program of the present embodiment to external apparatuses.

The storage medium 58 is a computer-readable storage medium storing, for example, execution programs. As a non-limiting example, the storage medium 58 may be implemented by a semiconductor memory such as a flash memory or a portable storage medium such as a CD-ROM or a DVD.

With the hardware configuration (hardware resources) as illustrated by FIG. 4 and installed execution programs (software resources) such as an information processing program, the computer (the server 11) can perform a display control process of the present embodiment.

### <Hardware Configuration of Terminal>

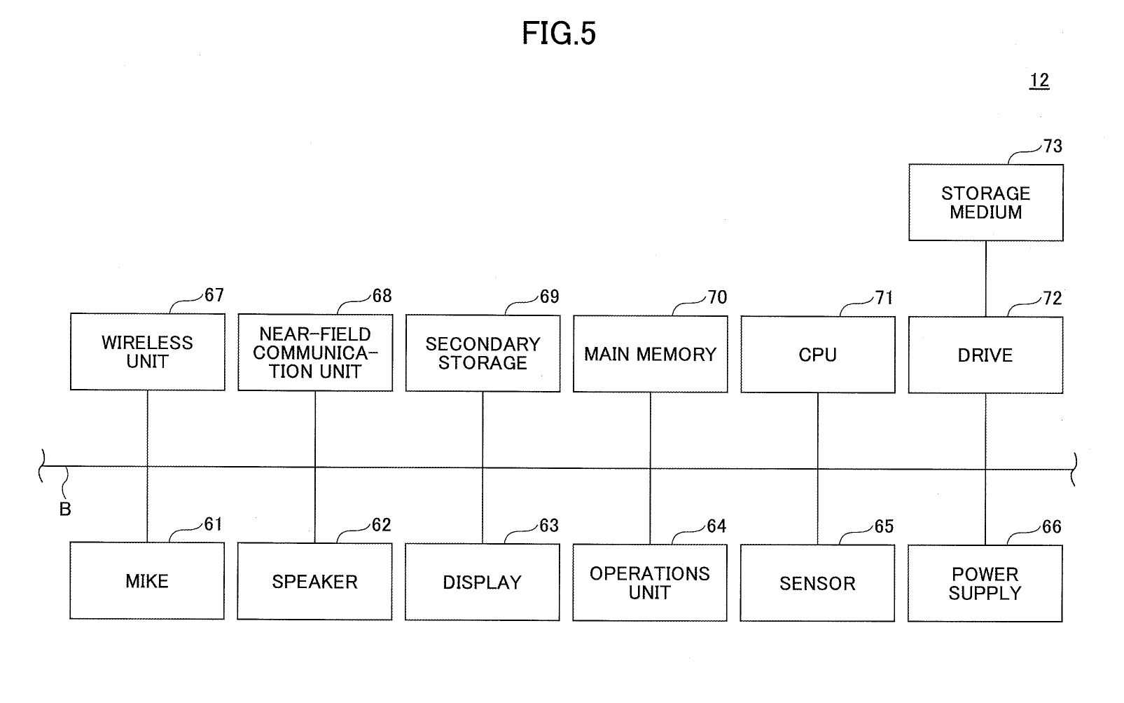

An exemplary hardware configuration of the terminal 12 is described below. FIG. 5 is a block diagram illustrating an exemplary hardware configuration of the terminal 12. As illustrated by FIG. 5, the terminal 12 may include a microphone (MIKE) 61, a speaker 62, a display 63, an operations unit 64, a sensor 65, a power supply 66, a wireless unit 67, a near-field communication unit 68, a secondary storage 69, a main memory 70, a CPU 71, and a drive 72 that are connected to each other via a system bus B.

The microphone 61 inputs voice uttered by a user and other sounds. The speaker 62 outputs voice of a communication partner and other sounds such as ringtone. The microphone 61 and the speaker 62 may be used to talk with a communication partner using a call function, and may also be used to input and output information via audio.

The display 63 displays, for a user, screens defined in the OS and various applications. When the display 63 is a touch panel display, the display 63 also functions as an input/output unit.

The display 63 may be implemented, for example, by a liquid crystal display (LCD) or an organic electroluminescence (EL) display.

The operations unit 64 may be implemented, for example, by operation buttons displayed on a screen of the display 63 or operation buttons provided on an outer surface of the terminal 12. The operation buttons may include, for example, a power button, a volume control button, and/or character input keys arranged in a predetermined order.

For example, when a user performs operations or presses the operation buttons on the screen of the display 63, the display 63 detects positions on the screen touched by the user. The display 63 can also display, on the screen, application execution results, contents, icons, a cursor, and so on.

The sensor 65 detects instantaneous and continuous movements of the terminal 12. As a non-limiting example, the sensor 65 detects a tilt angle, acceleration, an orientation, and a position of the terminal 12. The sensor 65 may include, but is not limited to, a tilt sensor, an acceleration sensor, a gyro sensor, and/or a global positioning system (GPS) sensor. The sensor 65 may also include an image sensor that is an example of the imager 32 for capturing objects and AR markers in a real space.

The power supply 66 supplies power to other components of the terminal 12. The power supply 66 is, for example, but is not limited to, an internal power source such as a battery. The power supply 66 may be configured to monitor its remaining power level by detecting the power level continuously or at predetermined intervals.

The wireless unit 67 is a transceiver that receives a radio signal (communication data) via, for example, an antenna from a base station and sends a radio signal (communication data) via the antenna to the base station. With the wireless unit 67, the terminal 12 can send and receive data via a base station and the communication network 13 to and from the server 11.

The near-field communication unit 68 performs near-field communications with computers such as other terminals 12 using a communication technology such as infrared communication, WiFi (registered trademark), or Bluetooth (registered trademark). The wireless unit 67 and the near-field communication unit 68 are examples of communication interfaces that enable the terminal 12 to send and receive data to and from other computers.

The secondary storage 69 is a storage device such as an HDD or an SSD. The secondary storage 69 stores programs and data, and performs data input/output as necessary.

The main memory 70 stores execution programs read by the CPU 71 from the secondary storage 69, and stores information obtained during the execution of the programs. The main memory 70 is, for example, but is not limited to, a ROM or a RAM.

The CPU 71 controls the entire terminal 12 (i.e., a computer) according to control programs such as an OS and execution programs stored in the main memory 70 to perform, for example, various calculations and data input/output between the CPU 71 and other hardware components, and thereby performs display control processes.

For example, the CPU 71 loads a program installed in the secondary storage 69 onto the main memory 70 and executes the loaded program according to an execution instruction input via the operations unit 64 to perform a process corresponding to the program. More specifically, the CPU 71 executes an information processing program to cause the setter 35 to set AR contents, object extraction criteria, and determination criteria, and cause the recognizer 37 to recognize reference objects such as AR markers. Also, the CPU 71 causes the acquirer 38 to obtain various types of information, causes the content generator 39 to generate AR contents, and causes the image generator 40 to generate images. Processes performed by the CPU 71 are not limited to those described above. Results of processes performed by the CPU 71 may be stored in the secondary storage 69 as necessary.

A storage medium 73 can be detachably set on the drive 72. The drive 72 can read and write information from and onto the set storage medium 73. The drive 72 is, for example, but is not limited to, a storage medium slot.

The storage medium 73 is a computer-readable storage medium storing, for example, execution programs. Examples of the storage medium 73 include, but are not limited to, a semiconductor memory such as a flash memory and a portable storage medium such as a USB memory.

With the hardware configuration (hardware resources) as illustrated by FIG. 5 and installed execution programs (software resources) such as an information processing program, the computer (the terminal 12) can perform a display control process of the present embodiment.

The information processing program for implementing a display control process of the present embodiment may be resident on a computer or activated in response to a start instruction.

### <Display Control Process>

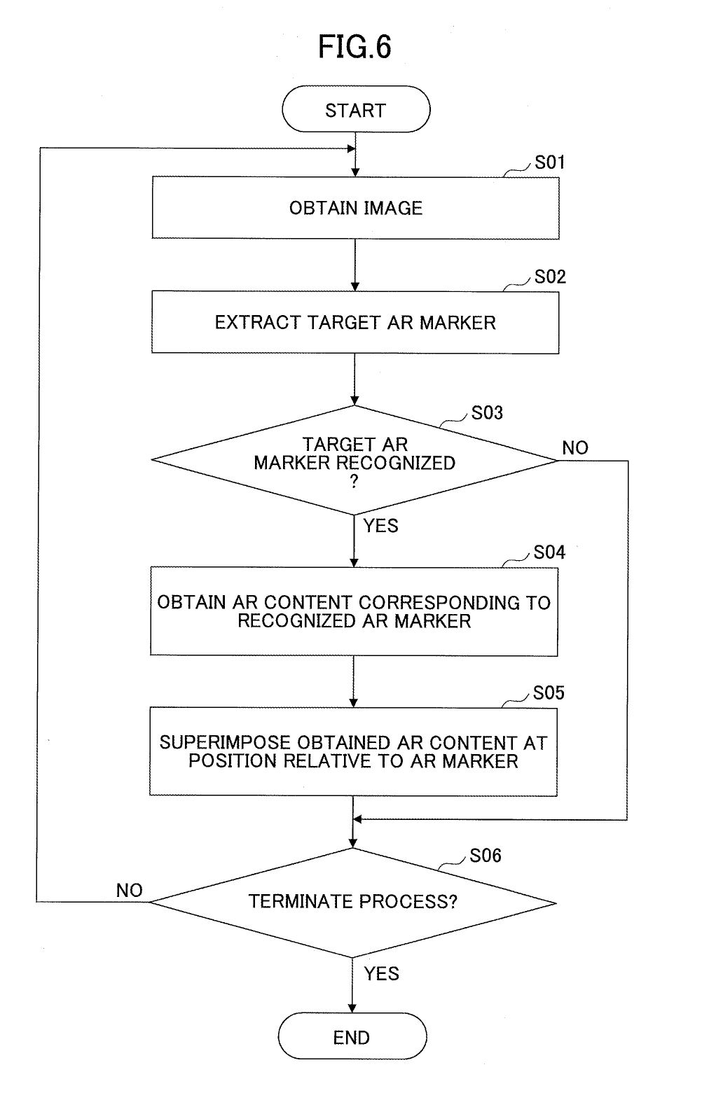

An exemplary display control process of the present embodiment is described below with reference to FIG. 6. FIG. 6 is a flowchart illustrating an exemplary display control process. As illustrated by FIG. 6, the imager 32 of the terminal 12 captures an image (S01). At this step, instead of an image captured by the imager 32, an image captured by or stored in an external apparatus connected via the communication network 13 to the terminal 12 may be obtained. Hereafter, an image captured by the imager 32 or obtained from an external apparatus is referred to as a “captured image”.

Next, the terminal 12 extracts a reference object (in this example, an AR marker) from the captured image (i.e., performs object recognition) (S02). In step S02, object recognition may be performed on a limited area of the captured image to reduce the number of AR contents to be displayed. Also in step S02, object recognition may be performed on the entire captured image, and a target reference object (target AR marker) whose AR content is to be displayed may be extracted from recognized reference objects based on, for example, the number of times the respective reference objects are recognized and/or the positions of the reference objects.

Next, the terminal 12 determines whether a target AR marker has been recognized (S03). When a target AR marker has been recognized (YES at S03), the terminal 12 obtains an AR content corresponding to the recognized AR marker (S04).

As a non-limiting example, the terminal 12, at step S04, sends a marker ID of the recognized AR marker to the server 11, and obtains an AR content corresponding to the marker ID from the server 11. As another example, the terminal 12 may be configured to search the storage 33 for an AR content corresponding to the marker ID, to obtain the AR content if it is stored in the storage 33, and to request the server 11 via the communication network 13 to send the AR content corresponding to the marker ID if the AR content is not stored in the storage 33.

Next, the terminal 12 superimposes the AR content obtained at step S04 on the captured image at a position relative to the corresponding AR marker (S05).

After step S5 or when it is determined at step S03 that no AR marker has been recognized (NO at S03), the terminal 12 determines whether to terminate the process (S06). When it is determined to not terminate the process (NO at S06), the process returns to step S01. When it is determined to terminate the process according to, for example, a termination instruction from the user (YES at step S06), the terminal 12 terminates the process.

### <Object Extraction Processes>

Object extraction processes of various embodiments corresponding to step S02 of FIG. 6 are described below.

### Object Extraction Process

### First Embodiment

In an object extraction process (S02) according to a first embodiment, a reference object(s) is extracted from a recognition area that is a partial area of image data. For example, the terminal 12 obtains image data, determines whether an image of a reference object (in this example, an AR marker) is included in a recognition area of the image data, and extracts the AR marker when it is included in the recognition area.

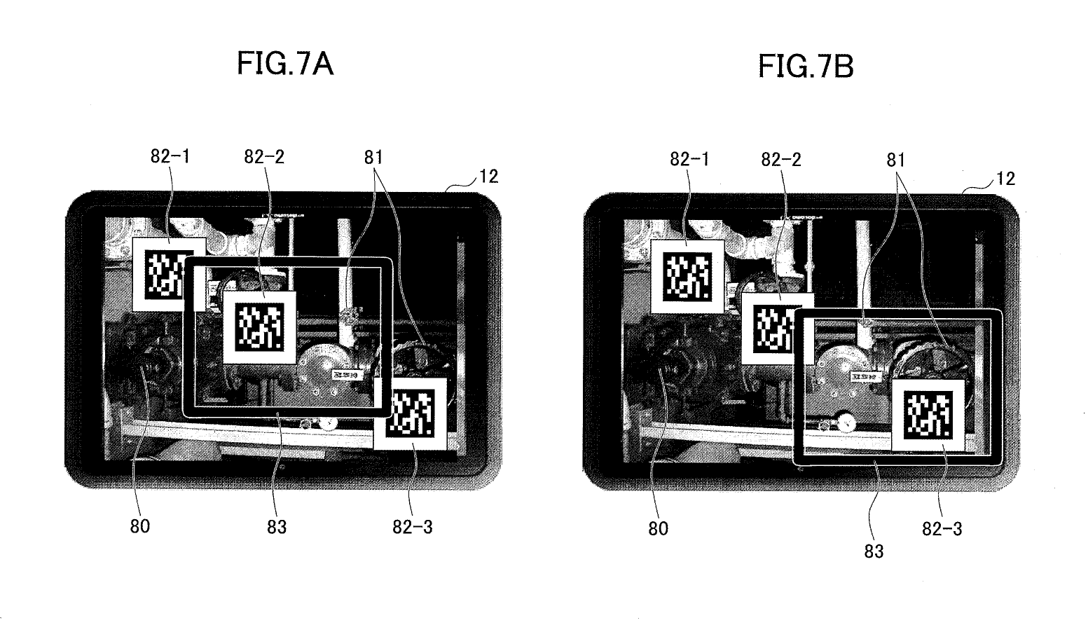

FIGS. 7A and 7B are drawings illustrating exemplary screens according to the first embodiment. Each of FIGS. 7A and 7B illustrates a screen of the terminal 12 on which a captured image 80 captured by the imager 32 is displayed. The captured image 80 includes objects 81 existing in a real space, and AR markers 82-1 through 82-3 for displaying AR contents corresponding to the objects 81. Any number of AR markers may be included in the captured image 80.

In the first embodiment, a recognition area is set on the screen of the terminal 12, and the terminal 12 determines whether image data of one or more of the AR markers 82 is included in the recognition area 83. The recognition area 83 may be set by a user in advance. For example, the recognition area may be positioned relative to a predetermined position on the screen (e.g., the center or a corner of the screen), and may have a size determined in proportion to the size of the screen of the terminal 12 or the size of the entire captured image 80. For example, the size of the recognition area 83 may be set in proportion to the size of the screen of the terminal 12.

In the example of FIG. 7A, the recognition area 83 is positioned relative to the center of the screen of the terminal 12, and has a size determined in proportion to the size of the screen of the terminal 12. In the example of FIG. 7B, the recognition area 83 is positioned relative to the lower-right corner of the screen of the terminal 12, and has a size determined in proportion to the size of the screen of the terminal 12. One or more recognition areas 83 may be set. When multiple recognition areas 83 are set, the sizes of the recognition areas 83 may be determined independently. The recognition area 83 may be indicated or not indicated on the screen.

According to the first embodiment, even when multiple AR markers are included in image data, only an AR marker(s) included in a recognition area is extracted, and an AR content(s) (other image data) corresponding to the extracted AR marker is superimposed on the image data. Thus, the first embodiment makes it possible to reduce the number of AR markers to be extracted, and thereby makes it possible to prevent too many AR contents from being superimposed on image data. The first embodiment also makes it possible to reduce the time necessary for a recognition process by limiting an area of image data on which the recognition process is performed.

### Object Extraction Process

### Second Embodiment

An exemplary object extraction process (S02) according to a second embodiment is described below. In the second embodiment, object recognition is performed on the entire image data, and when multiple AR markers are recognized in the image data, a target AR marker(s) whose AR content(s) is to be displayed is selected from the recognized AR markers to prevent too many AR contents corresponding to the recognized AR markers from being superimposed on the image data.

For example, in the second embodiment, the terminal 12 determines whether images of AR markers are included in image data obtained within a predetermined time period, counts the number of times each AR marker is recognized (i.e., the number of occurrences of each AR marker) in the image data (multiple images), and extracts a predetermined number of top AR markers in descending order of counting results. As a result, only AR contents corresponding to the extracted AR markers are superimposed on the image data.

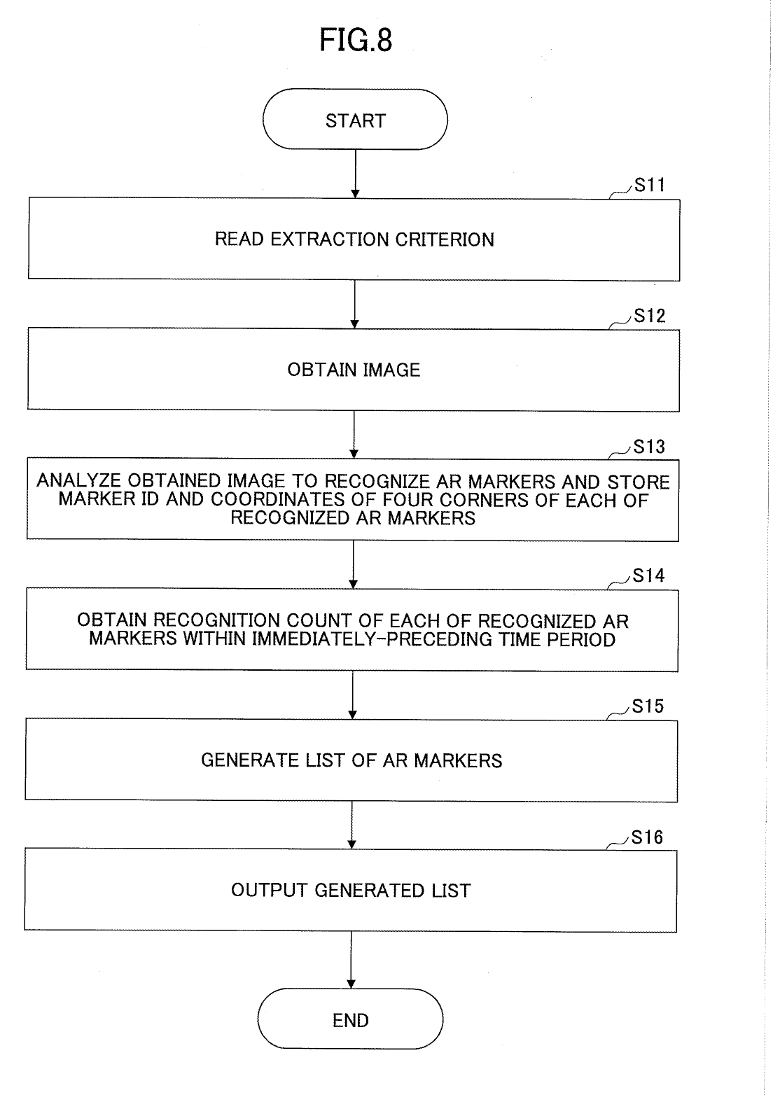

FIG. 8 is a flowchart illustrating an exemplary object extracting process according to the second embodiment. In the example of FIG. 8, the object extractor 36 reads an extraction criterion for extracting target AR markers whose AR contents are to be displayed (S11). In the second embodiment, the extraction criterion is based on a recognition count (frequency) indicating the number of times an AR marker is recognized in images within an immediately-preceding time period (which is predetermined). As a non-limiting example, the extraction criterion may indicate that a predetermined number of top AR markers in descending order of recognition counts are extracted.

Next, the object extractor 36 obtains images captured by, for example, the imager 32 (S12), analyzes the obtained images to recognize AR markers in the obtained images, and stores a marker ID and coordinates of four corners of each of the recognized AR markers (S13). Next, the object extractor 36 obtains a recognition count of each of the recognized AR markers within an immediately-preceding time period (S14).

Next, based on the recognition counts obtained at step S14 and the extraction criterion read at step S11, the object extractor 36 generates a ranking list (e.g., a recognition count table) of target AR makers whose AR contents are to be displayed (S15), and outputs the generated ranking list to, for example, the recognizer 37 (S16).

### Examples of Second Embodiment

Next, examples according to the second embodiment are described. In the second embodiment, target AR markers whose AR contents are to be displayed are extracted from AR markers included in image data based on recognition counts of the AR markers within a predetermined time period.

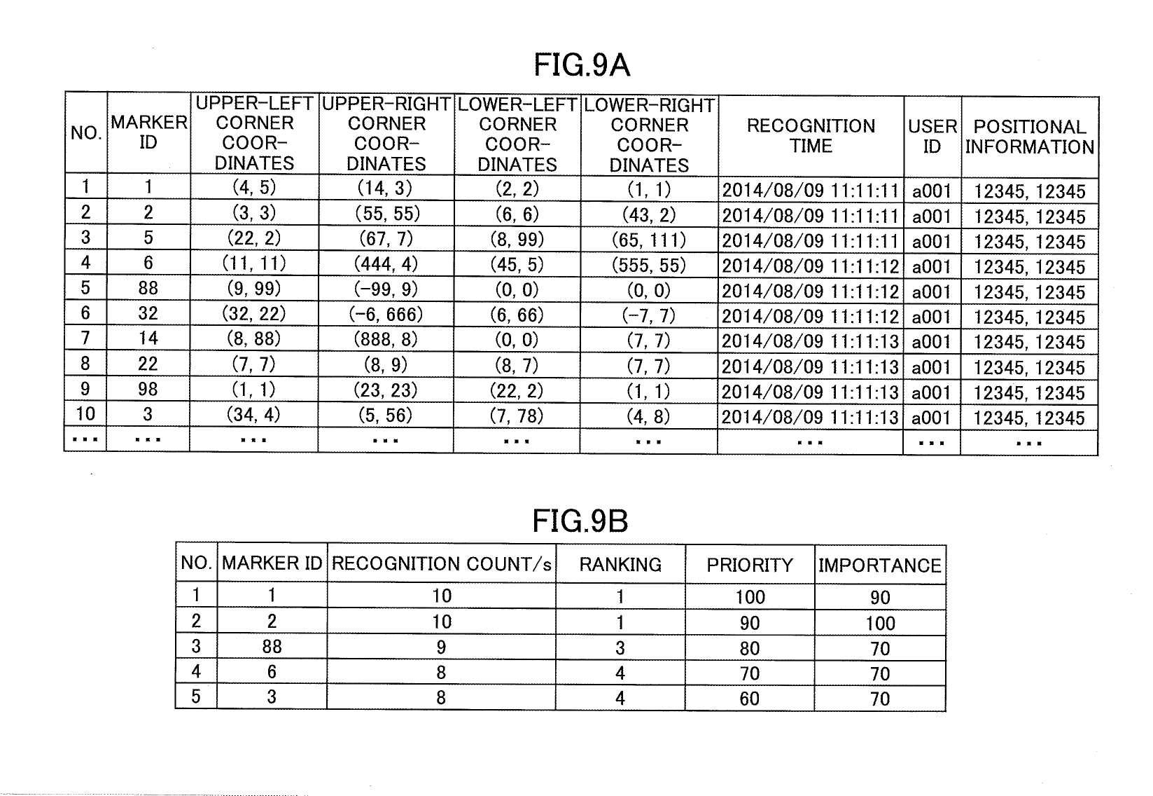

FIG. 9A is an example of an AR marker recognition information management table, and FIG. 9B is an example of a recognition count table.

Fields (information items) of the AR marker recognition information management table of FIG. 9A include, but are not limited to, “No.”, “marker ID”, “upper-left corner coordinates”, “upper-right corner coordinates”, “lower-left corner coordinates”, “lower-right corner coordinates”, “recognition time”, “user ID”, and “positional information”.

The “No.” field contains identification information for identifying a recognition result. The “marker ID” field contains identification information (marker ID) of a recognized AR marker. Each of the “upper-left corner coordinates” field, the “upper-right corner coordinates” field, the “lower-left corner coordinates” field, and the “lower-right corner coordinates” field contains coordinates of the corresponding corner (upper-left corner, upper-right corner, lower-left corner, lower-right corner) of a recognized AR marker. Here, it is assumed that an AR marker has a rectangular shape (e.g., square). The “recognition time” field contains a time when an AR marker recognition process is performed on obtained image data. The “user ID” field contains identification information of user who captured image data including the corresponding AR marker. The “positional information” field contains positional information indicating a position of the terminal 12 at the time when image data including the corresponding AR marker is captured. As a non-limiting example, the positional information may be obtained by a GPS function of the terminal 12 and represented by a latitude and a longitude.

For example, the target extractor 36 performs an AR marker recognition process on image data obtained from the imager 32, and when AR markers are recognized in the image data, stores information on the recognized AR markers in the AR marker recognition information management table of FIG. 9A.

Fields (information items) of the recognition count table of FIG. 9B include, but are not limited to, “No.”, “marker ID”, “recognition count”, “ranking”, “priority”, and “importance”.

The “No.” field contains identification information for identifying each record in the recognition count table. The “marker ID” field contains identification information (marker ID) of an AR marker. The “recognition count” field contains a recognition count indicating the number of times an AR marker is recognized within a predetermined time period. For example, when the imager 32 captures images at a frame rate of 10 fps (ten frames per second), the object extractor 36 analyzes images input at intervals of 0.1 sec, counts the number of times (recognition count) each AR marker is recognized, ranks recognized AR markers in descending order of recognition count per second, and thereby generates a recognition count table as illustrated by FIG. 9B. The recognition count table may contain only records of a predetermined number of top-ranked AR markers.

The “priority” field contains a priority level assigned to an AR marker (or marker ID). For example, the priority level may be determined in proportion to the ranking. That is, a higher priority level may be assigned to a higher-ranked AR marker. Also, a high priority level may be assigned to an AR marker that is recognized within the latest time period (e.g., a predetermined time period between the current time and a past time). Any other methods may also be used to determine the priority level.

The “importance” field contains an importance level that is assigned to an AR marker (or marker ID) in advance. For example, a higher importance level indicates that an AR content associated with the corresponding marker ID has higher importance. Examples of highly-important AR contents include, but are not limited to, “cautions” and “danger signs” that users need to know.

The interval or timing at which images are analyzed to recognize AR markers and the interval or timing at which the recognition count table is generated may be freely determined by the user. For example, the interval may be set based on a history of operations performed by a worker (i.e., a user) on objects (e.g., facilities). For example, 10 to 15 seconds may be set as an initial value of the interval.

It is highly likely that an AR marker of an AR content that a user wants to see is continuously included in image data during an immediately-preceding time period and is located near the center of image data. Therefore, in addition to the recognition count, the position of an AR marker in image data may also be used as an extraction criterion. In this case, for example, the priority level of a recognized AR marker may be set at a high value when the AR marker is located near the center of image data.

Also in the second embodiment, “recognition probability” may be used in addition to “recognition count” as an extraction criteria. Here, the recognition probability indicates a probability that an AR marker is recognized in image data when a recognition process is performed a predetermined number of times in a predetermined time period. As a non-limiting example, the recognition probability may be calculated by a formula “(recognition count in immediately-preceding time period)/((immediately-preceding time period [sec.])×(frame rate [fps]))”. For example, when the immediately-preceding time period is 1 second, the recognition count is 8, and the frame rate is 10 fps, the recognition probability is 8/(1×10)=0.8. In the recognition count table of FIG. 9B, AR markers may be ranked based on recognition probabilities obtained as described above.

The object extractor 36 extracts a predetermined number of AR markers based on the ranking (e.g., extracts a predetermined number of top-ranked AR markers). In the second embodiment, the recognizer 37 displays only AR contents of AR markers that are selected based on, for example, recognition counts from AR markers recognized in image data.

Also in the second embodiment, in addition to extracting a predetermined number of top-ranked AR markers in the ranking list, the object extractor 36 may be configured to extract, from the ranking list, at least one AR marker whose coordinates (position) come closer to the center of an image (e.g., when the size of the image is 640×320 dots, the center of the image is represented by center coordinates (320, 160)).

For example, when the coordinates of an AR marker with a marker ID “1” (AR marker “1”) recognized in an image are (x1, y1), a distance d1 of the AR marker “1” from the center coordinates of the image is obtained by “d1√((x1−320)²+(y1−160)²)”. When the coordinates of the AR marker “1” recognized in images captured at predetermined intervals change gradually from (x1, x1) to (x2, y2), (x3, y3), and (x4, y4), distances d2, d3, and d4 of the AR marker “1” from the center coordinates are also obtained in a similar manner.

In this case, when the distances from the center coordinates satisfy a condition “d4<d3<d2<d1”, an AR content corresponding to the AR marker “1” is superimposed on a screen. Although distances from the center coordinates are used in the above example, whether to extract an AR marker may be determined based on distances of the AR marker from a reference position specified by a user (e.g., by tapping) on a screen and a condition as described above. Also, an initial value of the reference position may be set in advance and may be freely changed by the user.

As illustrated by FIG. 9B, priority levels and/or importance levels may be assigned to recognized AR markers based on recognition counts, and marker IDs of the AR markers may be sent to the image generator 40 together the priority levels and/or the importance levels for later processing.

### <Exemplary Screens>

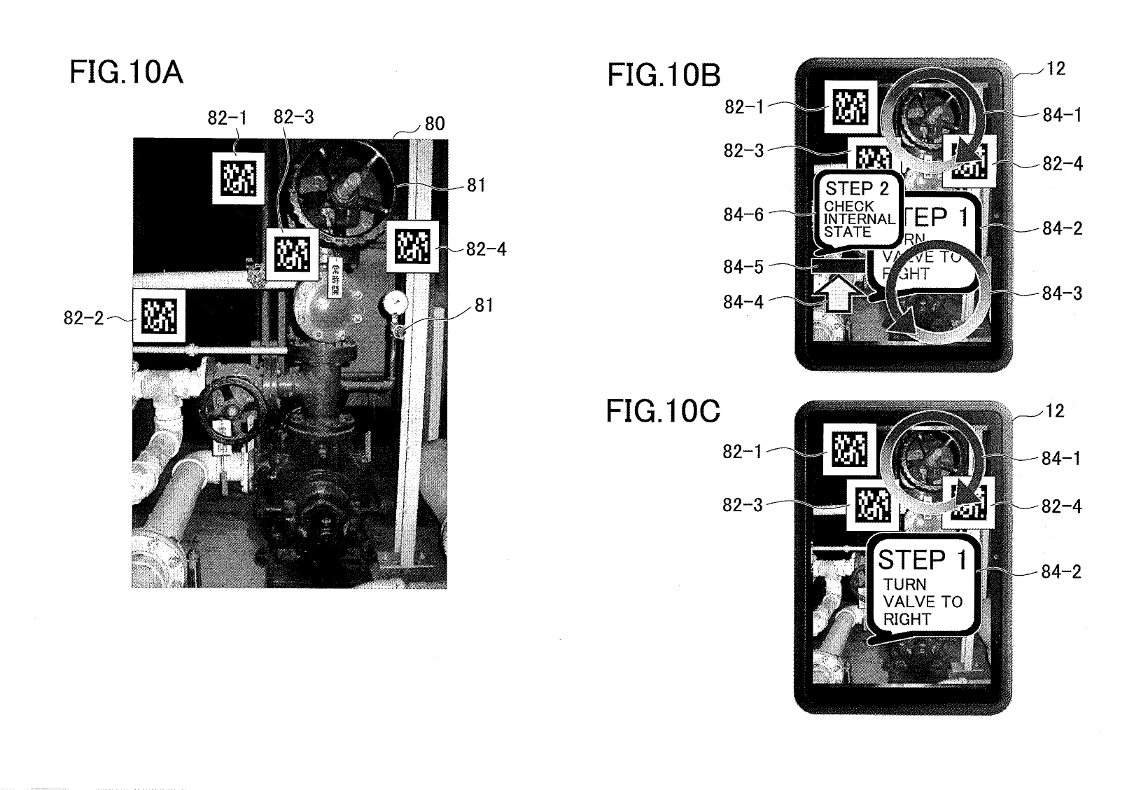

Next, the second embodiment is further described using exemplary screens. FIG. 10A illustrates an exemplary captured image 80. FIG. 10B illustrates an exemplary screen where AR contents corresponding to all AR markers recognized in the captured image 80 are displayed. FIG. 10C illustrates an exemplary screen 1i according to the second embodiment.

As illustrated by FIG. 10A, the captured image 80 includes objects 81 existing in a real space, and AR markers 82-1 through 82-4 for displaying AR contents corresponding to the objects 81. Any number of AR markers may be included in the captured image 80.

When marker recognition is performed on the captured image 80 of FIG. 10A and all AR contents 84-1 through 84-4 corresponding to the recognized AR markers 82-1 through 82-4 are superimposed on the captured image 80 as illustrated by FIG. 10B, the AR contents 84-1 through 84-4 overlap each other and become difficult to understand. This problem may be solved by selecting (or extracting) one or more AR markers based on recognition counts as described above, and displaying only AR contents corresponding to the selected AR markers. In the example of FIG. 10C, only the AR contents 84-1 and 84-2 are displayed.

### Object Extraction Process

### Third Embodiment

An exemplary object extraction process (S02) according to a third embodiment is described below. In the third embodiment, when multiple AR markers are included in image data, one or more of the AR markers in which the user seems to be interested are extracted based on positional information of the AR markers, positional information (GPS positional information) of the terminal 12, and a trace of movement of the terminal 12.

More specifically, in the third embodiment, a position of the terminal 12 and positions of AR markers are obtained, distances between the terminal 12 and the AR markers are calculated based on the obtained positions, and a predetermined number of AR markers whose distances from the terminal 12 gradually decrease over time are extracted. This makes it possible to superimpose only AR contents (other image data) corresponding to the extracted AR markers on image data.

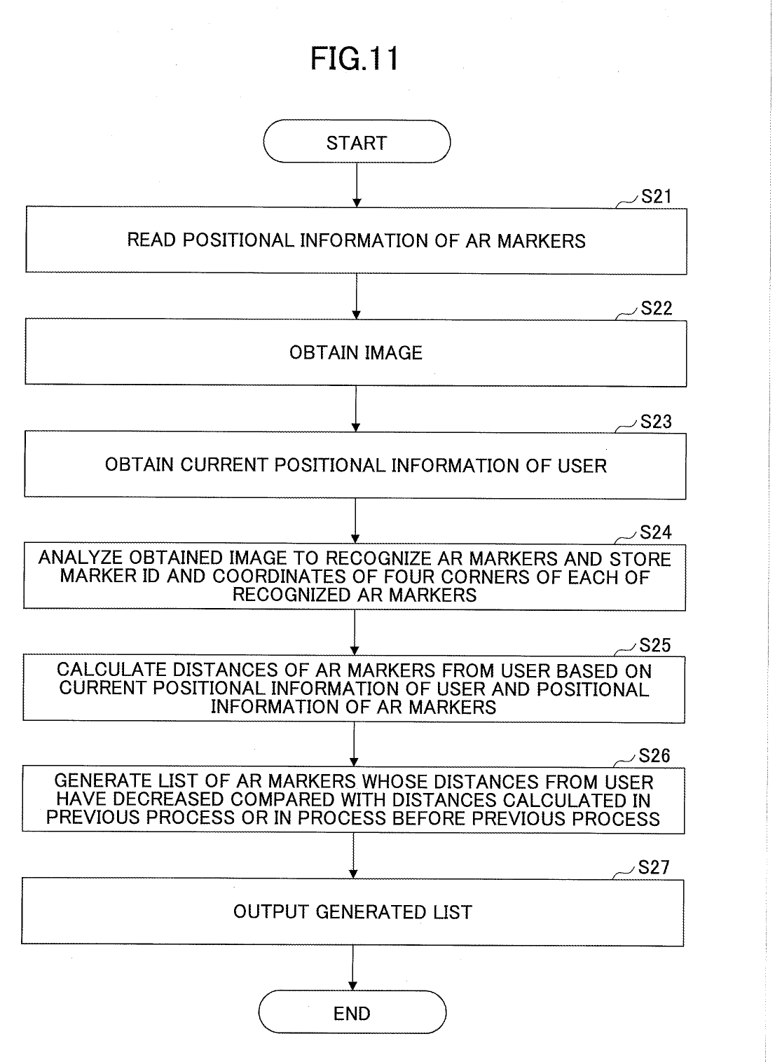

FIG. 11 is a flowchart illustrating an exemplary object extraction process according to the third embodiment. In the example of FIG. 11, the object extractor 36 reads positional information of AR markers (S21). For example, positional information of AR markers may be set when the AR markers are installed, or may be obtained by a GPS function of each of the AR markers.

Next, the object extractor 36 obtains an image captured by, for example, the imager 32 (S22). Also, the object extractor 36 obtains current positional information of a user (or the terminal 12) from, for example, a GPS function of the terminal 12 (S23). Next, the object extractor 36 analyzes the obtained image to recognize AR markers in the obtained image, and stores a marker ID and coordinates of four corners of each of the recognized AR markers (S24). Next, the object extractor 36 calculates distances between the user and the AR markers based on the current positional information of the user and the positional information of the AR markers (S25).

Then, the object extractor 36 generates a list of AR markers whose distances from the user (or the terminal 12) have decreased compared with distances calculated in a previous process or a process before the previous process (S26), and outputs the generated list to, for example, the recognizer 37 (S27).

### Examples of Third Embodiment

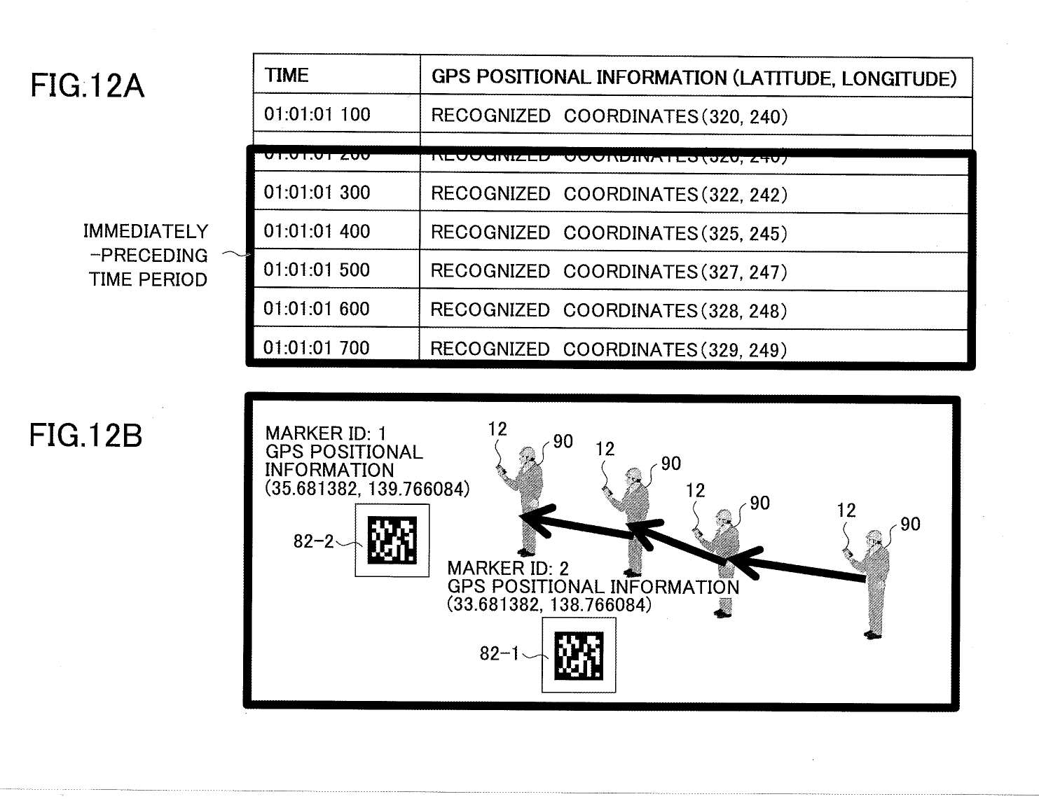

Next, examples according to the third embodiment are described. FIG. 12A is a drawing illustrating exemplary movement trace data, and FIG. 12B is a drawing illustrating exemplary movement of a user (the terminal 12).

In the third embodiment, only an AR content corresponding to an AR marker attached to an object in which a user seems to be interested is displayed based on, for example, a trace of movement of the user (behavior monitoring, traffic line management). In FIG. 12, 90 indicates a user such as a worker (or a wearable device such as a head-mounted display or a scouter worn by the user).

Information items of the movement trace data of FIG. 12A may include, but are not limited to, “time” and “GPS positional information”. The GPS positional information may be represented by a latitude and longitude. The exemplary movement trace data of FIG. 12A corresponds to a case illustrated by FIG. 12B where the user 90 moves toward AR markers 82. In this case, the terminal 12 extracts one of or a predetermined number of AR markers 82 whose distances from the user 90 gradually decrease as time passes, and superimposes only AR contents corresponding to the extracted AR markers 82.

For example, when the positional information of an AR marker is (x9, y9) and the GPS positional information of a user of the terminal 12 is (x1, y1), a distance d1 between the AR marker and the user is calculated by “d1=√((x1−x9)²+(y1−y9)²)”. When the positional information of the user gradually changes from (x1, y1) to (x2, y2), (x3, y3), and (x4, y4) due to movement of the user, distances d2, d3, and d4 between the AR marker and the user can be calculated in a similar manner. In this case, the terminal 12 extracts an AR marker whose distances from the user satisfy a condition “d4<d3<d2<d1”, and superimposes an AR content corresponding to the extracted AR marker on the screen.

### Object Extraction Process

### Fourth Embodiment

An exemplary object extraction process (S02) according to a fourth embodiment is described below. In the fourth embodiment, the terminal 12 assumes that the user is interested in an AR marker closest to the central portion of a screen of the terminal 12 or a position (specified position) on the screen tapped by the user, and extracts the AR marker. For example, in the fourth embodiment, the terminal 12 calculates distances between AR markers and a reference position on image data displayed on the display 34 (e.g., the center position of the image data or a user-specified position on the image data), and extracts a predetermined number of top AR markers in ascending order of the calculated distances. This makes it possible to superimpose only AR contents (other image data) corresponding to the extracted AR markers on the image data.

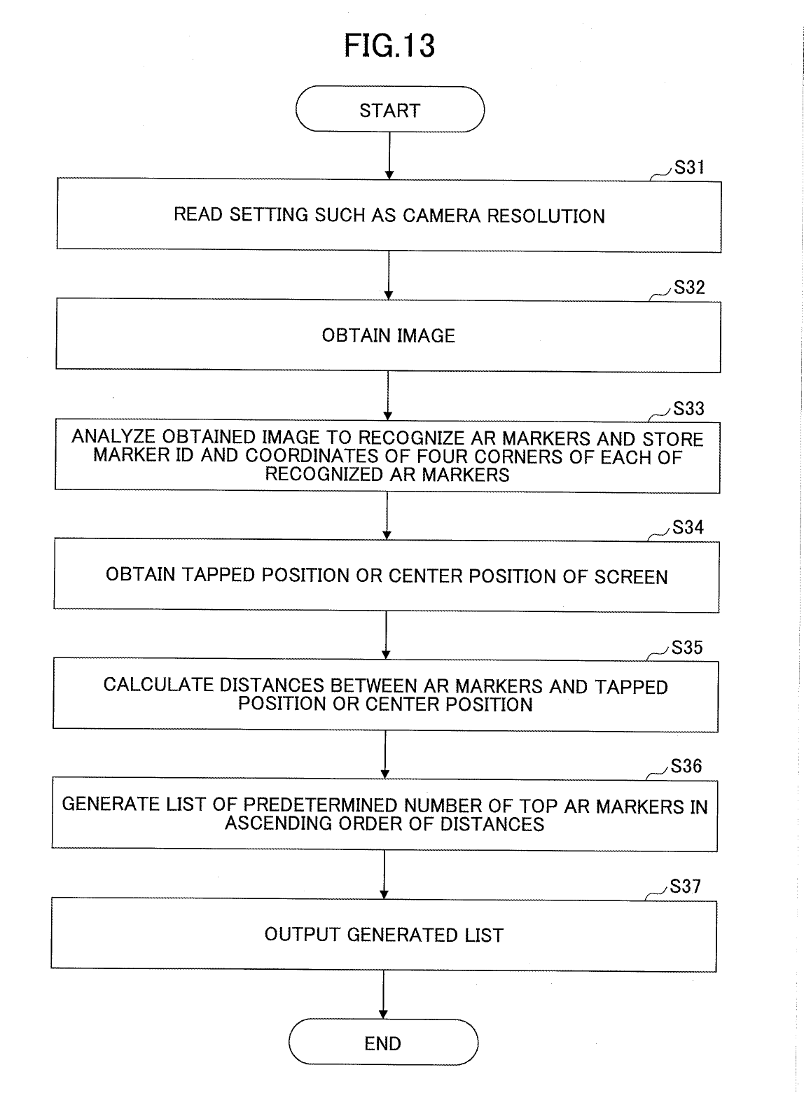

FIG. 13 is a flowchart illustrating an exemplary object extraction process according to the fourth embodiment. In the example of FIG. 13, the object extractor 36 reads settings such as a camera resolution of the imager 32 (S31). Next, the object extractor 36 obtains an image captured by the imager 32 (S32), analyzes the obtained image to recognize AR markers in the obtained image, and stores a marker ID and coordinates of four corners of each of the recognized AR markers (S33).

Next, the object extractor 36 obtains either a tapped position tapped by a user on the screen or the center position of the screen calculated based on the camera resolution read at step S31 (S34). The object extractor 36 may be configured to obtain the center position of the screen when the screen is not tapped for a predetermined time period, or may be configured to always obtain one of the center position or the tapped position.

Next, the object extractor 36 calculates distances between the recognized AR markers and the tapped position or the center position (S35). Then, the object extractor 36 generates a list including a predetermined number of top AR markers in ascending order of the distances (S36), and outputs the generated list to, for example, the recognizer 37 (S37).

### Examples of Fourth Embodiment

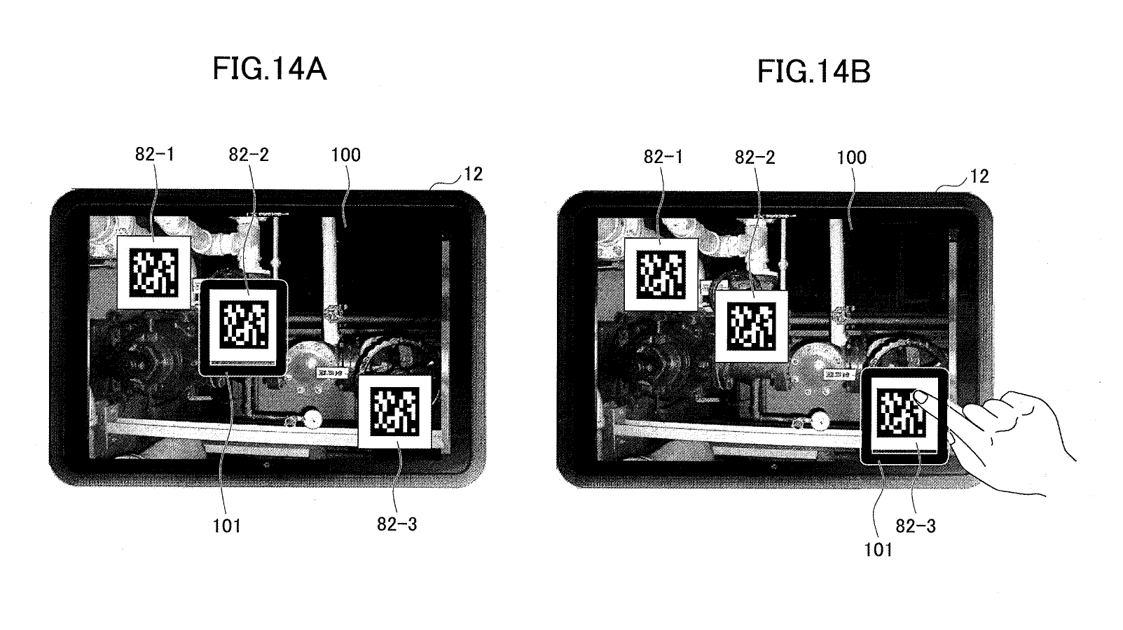

Next, examples according to the fourth embodiment are described. FIGS. 14A and 14B are drawings illustrating exemplary screens according to the fourth embodiment. In the example of FIG. 14A, from AR markers 82-1 through 82-3 included in a captured image 100 displayed on a screen of the terminal 12, the AR marker 82-2 closest to the center position of the screen is extracted, and an AR content corresponding to the extracted AR marker 82-2 is superimposed on the captured image 100.

For example, when the captured image 100 has a resolution of 640×320 and the positional information of the AR marker 82-1 is (x1, y1), a distance d1 between the center position of the screen and the AR marker 82-1 is calculated by “d1=√((x1−320)²+(y1−160)²)”. Similarly, when the positional information of the AR marker 82-2 is (x2, y2), a distance d2 between the center position of the screen and the AR marker 82-2 is calculated by “d2=√((x2−320)²+(y2−160)²)”. Also, when the positional information of the AR marker 82-3 is (x3, y3), a distance d3 between the center position of the screen and the AR marker 82-3 is calculated by “d3=√((x3−320)²+(y3−160)²)”. Based on the above calculation results, an AR content corresponding to one of the AR markers 82-1 through 82-3 (in this example, AR marker 82-2) whose distance d from the center position of the screen is smallest is superimposed on the captured image 100.

In the example of FIG. 14B, the terminal 12 assumes that the user is interested in an AR marker closest to a tapped position tapped by the user on the screen, and extracts the AR marker. For example, when the tapped position is (x9, y9), a distance d1 between the tapped position and the AR marker 82-1 is calculated by “d1=√(x1−x9)²+(y1−y9)²)”. Similarly, a distance d2 between the tapped position and the AR marker 82-2 is calculated by “d2=√((x2−x9)²+(y2−x9)²)”. Also, a distance d3 between the tapped position and the AR marker 82-3 is calculated by “d3=√((x3−x9)²+(y3−x9)³)”.

In the example of FIG. 14B, based on the above calculation results, the AR marker 82-3 whose distance d from the tapped position on the screen is smallest is extracted, and an AR content corresponding to the AR marker 82-3 is superimposed on the captured image 100.

Also in the fourth embodiment, a target AR marker, an AR content of which is being displayed, may be displayed in such a manner that the target AR marker is distinguishable from other AR markers in image data. For example, as illustrated in FIGS. 14A and 14B, a marker frame 101 indicating an extracted AR marker may be displayed on the screen of the terminal 12. The marker frame 101 enables a user to easily identify an extracted AR marker even when the AR marker is not located near the center of the screen of the terminal 12. In addition to using the marker frame 101, any other methods may also be used to indicate an extracted (target) AR marker. For example, an extracted (target) AR marker may be distinguished from other AR markers by color or by a superimposed mark.

As described above, an aspect of this disclosure makes it possible to prevent multiple images associated with reference objects from overlapping each other. For example, the embodiments of the present invention make it possible to reduce the number of AR markers to be extracted, and thereby make it possible to prevent too many AR contents from being superimposed on image data. Also, even when multiple AR markers are included in obtained image data, the embodiments of the present invention make it possible to select one or more of the AR markers according to a criterion, and thereby make it possible to prevent too many AR contents from being superimposed on the image data. This in turn makes it possible to reduce the workload of a field worker, to improve work efficiency, and to prevent human errors.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method performed by an information processing apparatus, the method comprising:
obtaining a captured image captured by an imaging device;
extracting one or more reference objects included in the captured image according to a predetermined rule; and
displaying one or more associated images associated with the extracted one or more reference objects on a display.

2. The method as claimed in claim 1, wherein according to the predetermined rule, the one or more reference objects are extracted from a recognition area corresponding to a partial area of the captured image.

3. The method as claimed in claim 1, further comprising:
determining frequencies at which the respective reference objects are included in captured images obtained within a predetermined time period,
wherein according to the predetermined rule, a predetermined number of top reference objects in descending order of the frequencies are extracted.

4. The method as claimed in claim 1, the method further comprising:
obtaining a position of the information processing apparatus and positions of the reference objects; and
calculating distances between the information processing apparatus and the reference objects based on the position of the information processing apparatus and the positions of the reference objects,
wherein according to the predetermined rule, one or more of the reference objects whose distances from the information processing apparatus decrease over time are extracted.

5. The method as claimed in claim 1, further comprising:
calculating distances of the reference objects from one of a center position of the captured image and a specified position specified by a user on the captured image,
wherein according to the predetermined rule, a predetermined number of top reference objects in ascending order of the calculated distances are extracted.

6. The method as claimed in claim 1, wherein in the displaying, the associated images are superimposed on the captured image displayed on the display.

7. The method as claimed in claim 1, wherein the extracted reference objects are displayed so as to be distinguishable from other reference objects in the captured image.

8. A non-transitory computer-readable storage medium having a program stored therein that causes a computer to execute a process, the process comprising:
obtaining a captured image captured by an imaging device;
extracting one or more reference objects included in the captured image according to a predetermined rule; and
displaying one or more associated images associated with the extracted one or more reference objects on a display.

9. An information processing apparatus, comprising:
a processor that executes a process, the process including
obtaining a captured image captured by an imaging device,
extracting one or more reference objects included in the captured image according to a predetermined rule, and
displaying one or more associated images associated with the extracted one or more reference objects on a display.
